(19) United States
(12) Patent Application Publication
(10) Pub. No.: US 2004/0001506 A1
(43) Pub. Date: Jan. 1, 2004

(54) Ethernet switch controller with console command logic unit and application apparatus thereof

(76) Inventors: Jen-Kai Chen, Taipei Hsien (TW); Yeong-Chian Hu, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,196

(22) Filed: Dec. 26, 2002

(30) Foreign Application Priority Data
Jul. 1, 2002 (TW) 91114491

(51) Int. Cl. H04L 12/66

(52) U.S. Cl. 370/463

(57) ABSTRACT

An Ethernet switch controller with console command logic unit and application apparatus thereof implemented with the least cost. The switch controller includes a serial port interface that connects with an external ASCII console. A user can input a serial character command through this console. The switch controller interprets and executes the command it received. When the command is a read command, the controller sends the result to be displayed on the console. Therefore, advance function commands can be implemented for the Ethernet switch to read data from or write data to a register within the Ethernet switch controller, a physical layer or an EEPROM.

### CROSS REFERENCE TO RELATED APPLICATIONS

This application claims the priority benefit of Taiwan application serial no. 91114491, filed Jul. 1, 2002.

### BACKGROUND OF INVENTION

1. Field of Invention

The present invention relates to an Ethernet apparatus. More particularly, the present invention relates to an Ethernet switch controller embedded with a console command logic unit and application apparatus thereof.

2. Description of Related Art

With the rapid advance in electronic technology, computers and various digital information systems are increasingly used in our daily life. To achieve resource sharing, networks have become an indispensable medium to exchange data. Among various types of networking systems, Ethernet Switch apparatus is easily acquired and installed with high data transmission rate, thus becoming the most popular equipment in the state of the art.

Requiring a physical layer circuit for the network connection ports, the Ethernet switch controller provides core specific application integrated circuits. Many functions including virtual local area network (VLAN), trunking and priority classification all depend on the switch controller. However, the parameters of most conventional switch controllers are set only when the power source is turned on.

A few other types of conventional switch controller provide a central processing unit (CPU) interface for setting different functional parameters through a microprocessor. Although this arrangement permits setting parameters, the system has the following defects:

1. Since one must write special microprocessor programs to set the parameters, the design is much complicated.

2. Because a microprocessor circuit is introduced, additional cost and failure points are incurred and hence reliability of the system is compromised.

### SUMMARY OF INVENTION

Accordingly, one object of the present invention is to provide a smart Ethernet switch controller with a console command logic unit capable of setting the parameters of various advance functions inside the switch controller through a serial port connected to the control console.

To achieve these and other advantages and in accordance with the purpose of the invention, as embodied and broadly described herein, the invention provides an Ethernet switch controller with a console command logic unit therein. The switch controller includes a physical layer connection interface, a serial port interface, a command logic unit and a switch controller unit. The physical layer connection interface connects with a physical layer (PHY) that provides a plurality of Ethernet connection ports. The serial port interface connects with a control console through a serial port driver. The switch control unit couples with the physical layer connection interface and the command logic unit for controlling the exchange of Ethernet packets transceived by Ethernet connection ports. The command logic unit couples with the serial port interface for receiving, interpreting and executing the command issued from the control console and responding to the execution results of the command when the command is a read command.

In one preferred embodiment of this invention, the serial port interface of the Ethernet switch controller is a RS232 interface. The commands are transmitted using the American Standard Code for Information Interchange (ASCII) code. The connected control console is an ASCII console or a personal computer simulated control console. When the control console is connected to a personal computer, the personal computer may include an application software to provide a personalized interface for users to input commands and display execution results.

In another preferred embodiment of this invention, the Ethernet switch controller may include an electrical erasable programmable read only memory (EEPROM) interface for connecting to an EEPROM for storing setting parameters. The Ethernet switch controller is applied to the Ethernet switch for accessing internal registers of the switch control unit, internal registers of the physical layer and the EEPROM so that various parameters of advance functions inside the switch can be set.

By applying the Ethernet switch controller having a control console command logic unit therein to an Ethernet switch, there is no need to equip a complicated microprocessor and design associated microprocessor programs because the Ethernet switch controller of this invention provides a serial port interface for connecting with the control console and provides a required command interpretation circuit. Therefore this invention achieves advance function setting capability.

It is to be understood that both the foregoing general description and the following detailed description are exemplary only, but not intended to limit the scope of the invention.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram of an Ethernet switch controller according to one preferred embodiment of this invention; and

FIG. 2 is a block diagram of an Ethernet switch according to one preferred embodiment of this invention.

### DETAILED DESCRIPTION

Reference will now be made in detail to the preferred embodiments of the invention, examples of which are illustrated in the accompanying drawings. Wherever possible, the same reference numbers are used in the drawings and the description to refer to the same or like parts.

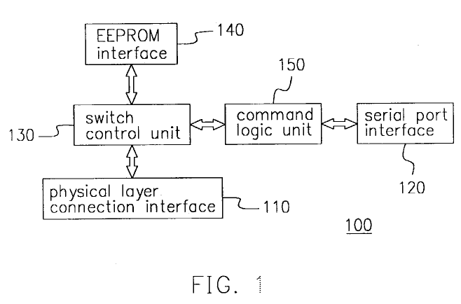

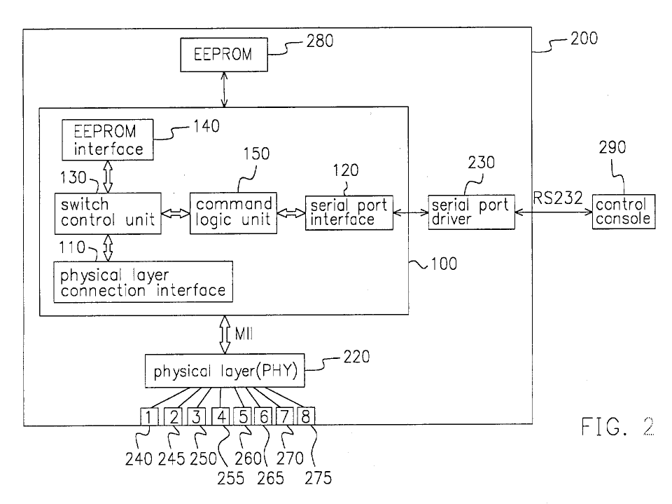

FIG. 1 is a block diagram of an Ethernet switch controller according to one preferred embodiment of this invention. FIG. 2 is a block diagram of an Ethernet switch according to one preferred embodiment of this invention. The Ethernet switch controller 100 in FIG. 1 includes a physical layer connection interface 110, a serial port interface 120, a command logic unit 150 and a switch control unit 130. To permanently store the parameter settings for the controller 100, such functions as virtual local area network (VLAN), trunking and priority classification, an EEPROM interface 140 is preferably provided in the Ethernet switch controller 100.

The physical layer connection interface 110 is an MII interface or SMI interface, for example. The physical layer connection interface 110 couples with a physical layer (PHY) 220 that provides a plurality of Ethernet connection ports. In this embodiment, eight Ethernet connection ports 240, 245, 250, 255, 260, 265, 270 and 275 are provided. Note that the number of Ethernet connection ports in the physical layer (PHY) 220 may change according to the type of Ethernet switch controller 110 used.

The serial port interface 120 connects with a control console 290 through a serial port driver 230. In this embodiment, the serial port interface 120 is, for example, an RS232 interface or other types of interface. The serial port driver 230 cooperates with the serial port interface 120. The control console 290 is, for example, an ASCII console or a personal computer simulated control console. When the control console is a computer-simulated console, the personal computer cooperating with an application software provides a human graphic interface for a user to input commands and display results.

The command logic unit 150 couples with the serial port interface 120 for receiving signals from the RS232 serial port, interpreting the signals and executing the command issued by the control console 290. Furthermore, the command logic unit 150 also responds to the execution result of the command when the command is a read command.

The switch control unit 130 couples with the physical layer connection interface 110, the command logic unit 150 and the EEPROM interface 140 for controlling the exchange of Ethernet packets transceiving through various Ethernet connection ports 240, 245, 250, 255, 260, 265, 270 and 275. By loading functional parameters from the EEPROM 280 or writing functional parameters to the EEPROM 280 via the EEPROM interface 140, functions such as VLAN, trunking and priority classification are adjusted. In addition, the command logic unit 150 is able to access the EEPROM 280 and internal registers of switch control unit 130 according to the control console command.

For example, the following command format is defined for the commands issued by the control console 290:

<prompt>[<address><operator>[<data>]]<carriage return>

Here, the command prompt is, for example, the symbol “>”. The symbol is issued by the on-line Ethernet switch controller 100. Thereafter, a user may start to key in a command string following the prompt symbol. The command string includes the address for accessing the internal registers or data in the EEPROM, the operation field indicating the command type, the data field to provide a write data and the carriage return field indicating the end of the command string. The address field is represented, preferably, by four hexadecimal byte words. The data field is not required for a data read command. For a data write command, a decimal or hexadecimal byte word value is input according to the operator.

The operators for different commands are listed as follows, for example: Operator “<=” represents a read/write command using a decimal format to access an internal register of the switch controller.

Operator “:=” represents a read/write command using a hexadecimal format to access an internal register of the switch controller.

Operator “= =” represents a read/write EEPROM command using a hexadecimal format.

Operator “\hat{ }=” represents a read/write command using a hexadecimal format to access an internal register of the physical layer device.

When the data field is absent, a read data command is implicated. Otherwise, a write data command is implicated. Of course, before typing the carriage return, pressing the backspace key is able to correct any incorrect input words. Command examples are provided in the following:

“[Enter]” represents a return key.

“>[Enter]” indicates the input command word is a null command.

“>03F8<=123[Enter]” indicates writing a decimal value 123 to the register 03F8h inside the switch controller.

“>03F8<=[Enter]” indicates reading the register at address 03F8h inside the switch controller in decimal format.

“123” indicates a decimal reading result 123 on the display.

“>03F8:=1F[Enter]” indicates writing a hexadecimal value 1F to the register at 03F8h inside the switch controller.

“>03F8:=[Enter]” indicates reading a hexadecimal value from the register at address 03F8.

“1F” indicates a hexadecimal reading result 1F on the display.

“>0001= =[Enter]” indicates writing the hexadecimal value 0A from the EEPROM at address 0001h.

“>0001= =[Enter]” indicates reading the hexadecimal value from the EEPROM at address 0001h.

“0A” indicates a hexadecimal reading result 0A on the display.

“>0004\hat{ }=[Enter]” indicates reading the hexadecimal value from the register at address 0004h inside the physical layer (PHY).

“03” indicates a hexadecimal reading result 03 on the display.

“>” is a prompt symbol waiting for the next key-in command.

For system safety, the password verification function should be provided. That is, on system start-up or when an input command period, such as 60 seconds, has already expired, a specific command should be provided for password verification. For example, to store a password 1234 in EEPROM addresses 00FEh and 00FFh, the command 00FE = = 12 and the command 00FF = = 34 are input to the switch controller to identify. If the input code is incorrect, the system stops any input command for a period, such as 15 seconds. Thereafter, a command prompt symbol is displayed waiting for the input of another command.

In summary, applying the Ethernet switch controller of this invention to the Ethernet switch has at least the following advantages:

1. Capable of flexibly setting various advance functions inside the switch at low cost.

2. Greatly simplifying the switch circuit and the associated design for functional setting.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An Ethernet switch controller, comprising:
a physical layer connection interface for connecting with a physical layer device that provides a plurality of Ethernet connection ports;
a serial port interface for connecting with a control console through a serial port driver;
a command logic unit coupled to the serial port interface for receiving and interpreting commands from the serial port interface and executing a command issued by the control console; and
a switch control unit coupled to the physical layer connection interface and the command logic unit for controlling the exchange of Ethernet packets transceived by said Ethernet connection ports and providing a data access path to the command logic unit.

2. The switch controller of claim 1, wherein the serial port interface includes a RS232 interface.

3. The switch controller of claim 1, wherein is transmitted using an American Standard Code for Information Interchange (ASCII) code.

4. The switch controller of claim 3, wherein the control console is an American Standard Code for Information Interchange (ASCII) console.

5. The switch controller of claim 3, wherein the control console is a personal computer.

6. The switch controller of claim 5, wherein the personal computer further includes an application software to provide a human graphic interface for a user to input and display said command.

7. The switch controller of claim 1, wherein the controller further includes an electrical erasable programmable read only memory (EEPROM) interface for connecting with an EEPROM for storing a plurality of parameters.

8. The switch controller of claim 7, wherein the command instructs the switch controller unit to read parameter from or write parameters to the EEPROM.

9. The switch controller of claim 1, wherein the command- instructs the switch controller unit to read parameters from or write parameters to registers within the switch control unit.

10. The switch controller of claim 1, wherein the command instructs the switch controller unit to read parameters from or write parameters to registers within the physical layer device.

11. An Ethernet switch, comprising:
a physical layer device that provides a plurality of Ethernet connection ports;
a serial port driver that provides a serial port for connecting with a control console; and
a switch controller coupled with the physical layer and the serial port driver for controlling the exchange of a plurality of Ethernet packets transceived from said Ethernet connection ports, receiving, interpreting, and executing a command issued by the control console.

12. The Ethernet switch of claim 11, wherein the serial port is a RS232 serial port.

13. The Ethernet switch of claim 11, wherein the command is issued using an American Standard Code for Information Interchange (ASCII) code.

14. The Ethernet switch of claim 13, wherein the control console is an American Standard Code for Information Interchange (ASCII) console.

15. The Ethernet switch of claim 13, wherein the control console is a personal computer.

16. The Ethernet switch of claim 15, wherein the personal computer further includes an application software to provide a human graphic interface for a user to input and display said command.

17. The Ethernet switch of claim 11, wherein the controller further includes an electrical erasable programmable read only memory (EEPROM) interface for connecting with an EEPROM for storing a plurality of parameters.

18. The Ethernet switch of claim 17, wherein the command instructs the switch controller unit to read parameters from or write parameters to the EEPROM.

19. The Ethernet switch of claim 11, wherein the command instructs the switch controller unit to read parameters from or write parameters to registers within the switch control unit.

20. The Ethernet switch of claim 11, wherein the command instructs the switch controller unit to read parameters from or write parameters to registers within the physical layer device.
